(19) United States
(12) Patent Application Publication
(10) Pub. No.: US 2012/0052761 A1
(43) Pub. Date: Mar. 1, 2012

(54) METHOD FOR PRODUCING PLASMA DISPLAY PANEL

(76) Inventors: Hai Lin, Osaka (JP); Takehiro Zukawa, Osaka (JP); Eiji Takeda, Osaka (JP); Tasuku Ishibashi, Osaka (JP); Kyohei Yoshino, Osaka (JP); Kazuya Nomoto, Osaka (JP); Takuji Tsujita, Osaka (JP)

(21) Appl. No.: 13/265,964

(22) PCT Filed: Mar. 16, 2011
(86) PCT No.: PCT/JP2011/001527

§ 371 Date: Oct. 24, 2011

(30) Foreign Application Priority Data
Mar. 26, 2010 (JP) 2010-071981

(51) Int. Cl. H01J 9/20

(52) U.S. Cl. 445/24

(57) ABSTRACT

A method for producing a plasma display panel including a base layer containing a metal oxide, and aggregated particles dispersed on the base layer includes the following process. A protective layer is formed on a dielectric layer. Then, a surface of the protective layer is sputtered. In addition, concentration ratios of a first metal oxide and a second metal oxide in the surface of the protective layer are changed by re-depositing a component of the sputtered protective layer.

### TECHNICAL FIELD

A technique disclosed here relates to a method for producing a plasma display panel used in a display device and the like.

### BACKGROUND ART

A plasma display panel (hereinafter, referred to as the PDP) is composed of a front plate and a rear plate. The front plate is composed of a glass substrate, a display electrode formed on one main surface of the glass substrate, a dielectric layer to cover the display electrode and serve as a capacitor, and a protective layer formed on the dielectric layer and made of a magnesium oxide (MgO). Meanwhile, the rear plate is composed of a glass substrate, a data electrode formed on one main surface of the glass substrate, an base dielectric layer to cover the data electrode, a barrier rib formed on the base dielectric layer, and phosphor layers formed between the barrier ribs and emitting red, green, and blue light, respectively.

The front plate and the rear plate are hermetically sealed with their electrode forming surfaces opposed to each other. A discharge gas such as neon (Ne) and xenon (Xe) is sealed in a discharge space sectioned by the barrier rib. The discharge gas causes discharge by a video signal voltage selectively applied to the display electrode. Ultraviolet rays generated by the discharge excite each phosphor layer. The excited phosphor layer emits red, green, or blue light. The PDP provides a color image display (refer to PTL 1) as described above.

The protective layer mainly has four functions. A first function is to protect the dielectric layer from ion bombardment caused by the discharge. A second function is to emit initial electrons to generate data discharge. A third function is to retain electric charges to generate the discharge. A fourth function is to emit secondary electrons at the time of sustain discharge. When the dielectric layer is protected from the ion bombardment, a discharge voltage is prevented from rising. When the initial electron emission number is increased, a data discharge error causing flickering in an image is reduced. When charge retention performance is improved, an applied voltage is reduced. When the secondary electron emission number is increased, a sustain discharge voltage is reduced. In order to increase the initial electron emission number, an attempt to add silicon (Si) or aluminum (Al) to MgO of the protective layer is made (refer to PTLs 1, 2, 3, 4, and 5, for example).

### CITATION LIST

### Patent Literature

[PTL 1] Unexamined Japanese Patent Publication No. 2002-260535
[PTL 2] Unexamined Japanese Patent Publication No. 11-339665
[PTL 3] Unexamined Japanese Patent Publication No. 2006-59779
[PTL 4] Unexamined Japanese Patent Publication No. 8-236028
[PTL 5] Unexamined Japanese Patent Publication No. 10-334809

### SUMMARY OF THE INVENTION

A method for producing a PDP is provided, and the PDP includes a rear plate, and a front plate disposed oppositely to the rear plate. The front plate has a glass substrate, a display electrode formed on the glass substrate, a dielectric layer to cover the display electrode, and a protective layer to cover the dielectric layer. The display electrode includes a strip-shaped scan electrode, and a strip-shaped sustain electrode provided parallel to the scan electrode. The protective layer includes a base layer formed on the dielectric layer. Aggregated particles composed of aggregated crystal particles made of a magnesium oxide are dispersed all over the base layer. The base layer contains at least a first metal oxide and a second metal oxide. The base layer has at least one peak through an X-ray diffraction analysis. The peak of the base layer exists between a first peak of the first metal oxide through an X-ray diffraction analysis and a second peak of the second metal oxide through an X-ray diffraction analysis. The first peak and the second peak show the same surface orientation as a surface orientation shown by the peak. The first metal oxide and the second metal oxide are composed of two kinds of oxides selected from a group consisting of a magnesium oxide, a calcium oxide, a strontium oxide, and a barium oxide.

The method for producing the PDP includes following processes. The display electrode is formed on the glass substrate. Then, the dielectric layer to cover the display electrode is formed. Then, the protective layer is formed on the dielectric layer. Then, a voltage is applied to the scan electrode and the sustain electrode to cause discharge between the scan electrode and the sustain electrode under an inert gas atmosphere, whereby an ion of the inert gas is generated to sputter the protective layer.

### BRIEF DESCRIPTION OF DRAWINGS

FIG. 1 is a perspective view showing a structure of a PDP according to an exemplary embodiment.

FIG. 2 is a cross-sectional view showing a configuration of a front plate according to the embodiment.

FIG. 3 is a view showing an electrode arrangement of the front plate according to the embodiment.

FIG. 4 is a view showing steps for producing the PDP according to the embodiment.

FIG. 5 is a view showing the front plate according to the embodiment.

FIG. 6 is a view showing the PDP according to the embodiment taken from a side of the rear plate.

FIG. 7 is a view showing a result of an X-ray diffraction analysis of a base film according to the embodiment.

FIG. 8 is a view showing a result of an X-ray diffraction analysis of a base film having another configuration according to the embodiment.

FIG. 9 is an enlarged view of aggregated particles according to the embodiment.

FIG. 10 is a view showing a relationship between a discharge delay and a calcium (Ca) concentration in a protective layer in the PDP according to the embodiment.

FIG. 11 is a view showing a relationship between electron emission performance and a Vscn lighting voltage in the above PDP.

FIG. 12 is a view showing a relationship between an average particle diameter of an aggregated particle and electron emission performance according to the embodiment.

FIG. 13 is a view showing a relationship between the average particle diameter of the aggregated particle and a barrier rib fracture probability according to the embodiment.

FIG. 14 is a view showing steps for forming the protective layer according to the embodiment.

FIG. 15 is a view showing a discharge device according to the embodiment.

FIG. 16 is a view of a drive waveform of voltage applied to the PDP according to the embodiment.

### DESCRIPTION OF EMBODIMENTS

### 1. Basic Structure of PDP

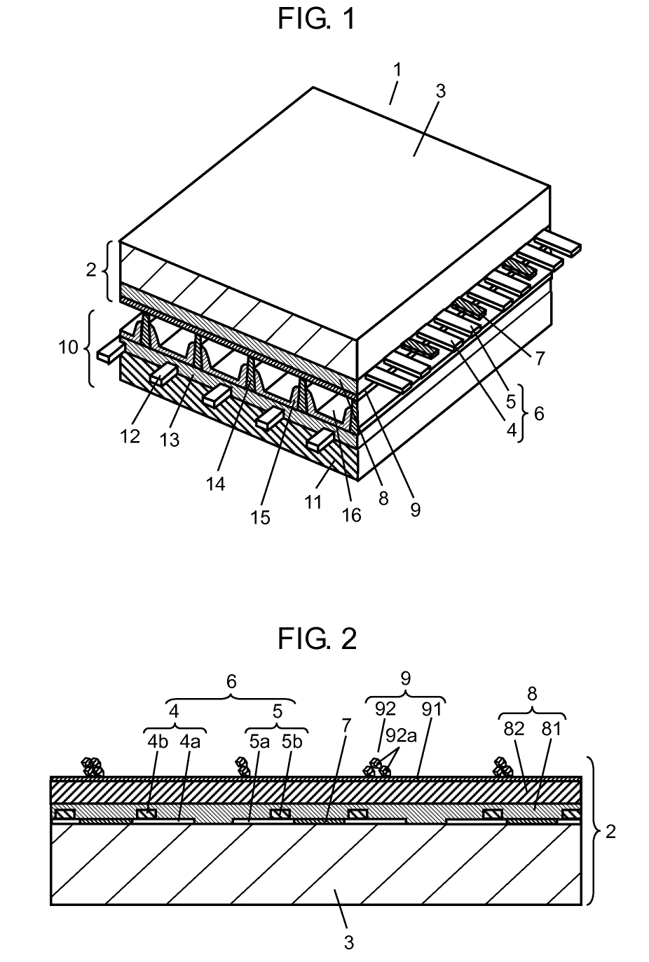

A basic structure of a PDP corresponds to that of a general alternating current (AC) surface discharge type PDP. As shown in FIG. 1, PDP 1 is provided in such a manner that front plate 2 including front glass substrate 3, and rear plate 10 including rear glass substrate 11 are arranged so as to be opposed to each other. Peripheral parts of front plate 2 and rear plate 10 are hermetically sealed with a sealing material composed of a glass frit. A discharge gas such as Ne or Xe is sealed at a pressure of 53 kPa to 80 kPa in discharge space 16 provided in sealed PDP 1.

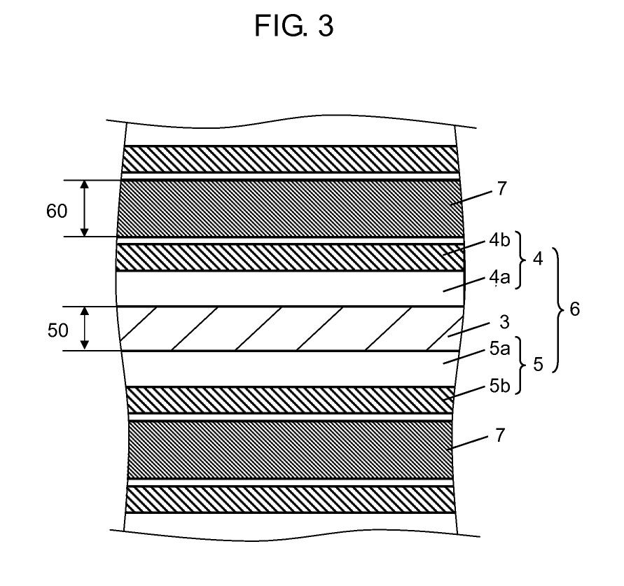

Strip-shaped display electrodes 6 each composed of a pair of scan electrode 4 and sustain electrode 5, and black stripes 7 are arranged on front glass substrate 3 so as to be parallel to each other. Dielectric layer 8 serving as a capacitor is formed on front glass substrate 3 so as to cover display electrodes 6 and black stripes 7. In addition, protective layer 9 composed of MgO is formed on a surface of dielectric layer 8. In addition, as shown in FIG. 2, protective layer 9 according to the embodiment includes base film 91 laminated on dielectric layer 8 and serving as a base layer, and aggregated particles 92 attached on the base film 91. In addition, as shown in FIG. 3, main gap 50 is formed in a relatively small region provided between scan electrode 4 and sustain electrode 5. Main gap 50 is a region in which sustain discharge is generated in PDP 1. Inter-pixel gap 60 is formed in a relatively large region provided between scan electrode 4 and sustain electrode 5. The sustain discharge does not reach inter-pixel gap 60. That is, the discharge region is roughly provided between scan electrode 4 and sustain electrode 5 across main gap 50.

Each of scan electrode 4 and sustain electrode 5 is constituted in such a manner that a bus electrode containing Ag is laminated on a transparent electrode composed of a conductive metal oxide such as an indium tin oxide (ITO), a tin dioxide (SnO₂), or a zinc oxide (ZnO).

Data electrodes 12 each composed of a conductive material mainly containing silver (Ag) are arranged parallel to each other on rear glass substrate 11, in a direction perpendicular to display electrodes 6. Data electrode 12 is covered with base dielectric layer 13. Furthermore, barrier rib 14 having a predetermined height is formed on base dielectric layer 13 to section discharge space 16, between data electrodes 12. Phosphor layer 15 emitting red light, phosphor layer 15 emitting green light, and phosphor layer 15 emitting blue light under ultraviolet rays are sequentially applied and formed with respect to each data electrode 12, on base dielectric layer 13 and on a side surface of barrier rib 14. A discharge cell is formed at an intersecting position of display electrode 6 and data electrode 12. The discharge cell having red, green, and blue phosphor layers 15 arranged in a direction along display electrode 6 serves as a pixel for a color display.

In addition, according to this embodiment, the discharge gas sealed in discharge space 16 contains 10 vol. % to 30 vol. % of Xe.

### 2. Method for Producing PDP

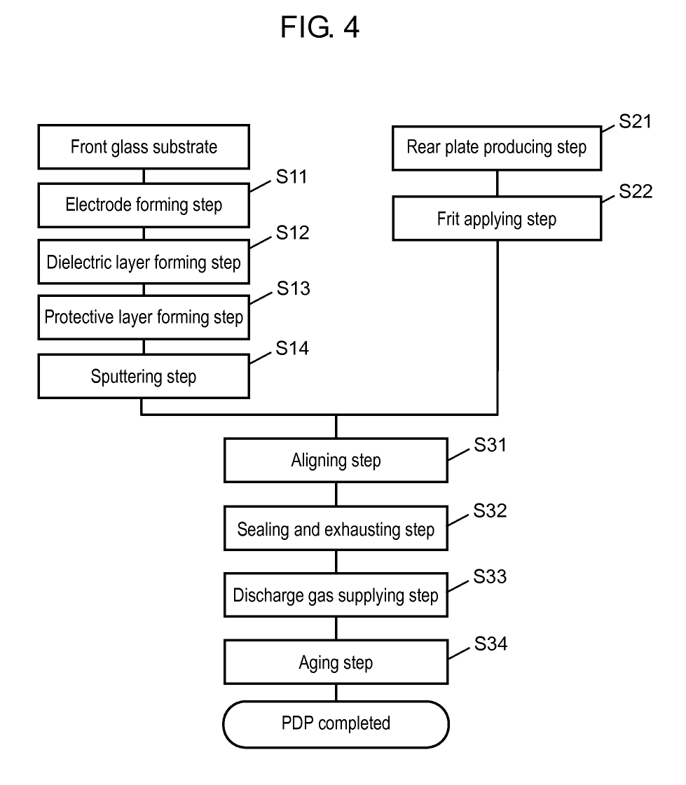

Then, a description will be made of a method for producing PDP 1 with reference to FIG. 4.

First, a method for producing front plate 2 will be described. As shown in FIG. 4, in electrode forming step S11, scan electrode 4, sustain electrode 5, and black stripe 7 are formed on front grass substrate 3 by photolithography. Scan electrode 4 and sustain electrode 5 have bus electrodes 4b and 5b containing Ag, respectively to ensure conductivity. In addition, scan electrode 4 and sustain electrode 5 have transparent electrodes 4a and 5a, respectively. Bus electrode 4b is laminated on transparent electrode 4a. Bus electrode 5b is laminated on transparent electrode 5a.

Transparent electrodes 4a and 5a are each made of ITO to ensure transparency and electric conductivity. First, an ITO thin film is formed on front glass substrate 3 by sputtering. Then, transparent electrodes 4a and 5a are formed into predetermined patterns by lithography.

As materials of bus electrodes 4b and 5b, a white paste containing Ag, a glass frit to bind Ag, a photosensitive resin, and a solvent is used. First, the white paste is applied onto front glass substrate 3 by screen printing. Then, the solvent is removed from the white paste in a furnace. Then, the white paste is exposed with a photomask having a predetermined pattern put thereon.

Then, the white paste is developed and a bus electrode pattern is formed. Finally, the bus electrode pattern is fired at a predetermined temperature in the furnace. That is, the photosensitive resin is removed from the bus electrode pattern. In addition, the glass frit melts in the bus electrode pattern. The molten glass frit becomes glass after fired. Through the above steps, bus electrodes 4b and 5b are formed.

Thus, main gap 50 is formed in a relatively small region between transparent electrode 4a and transparent electrode 5a. Inter-pixel gap 60 is formed in a relatively large region between transparent electrode 4a and transparent electrode 5a.

Black stripe 7 is formed of a material containing a black pigment. Black stripe 7 is formed between display electrodes 6 by screen printing.

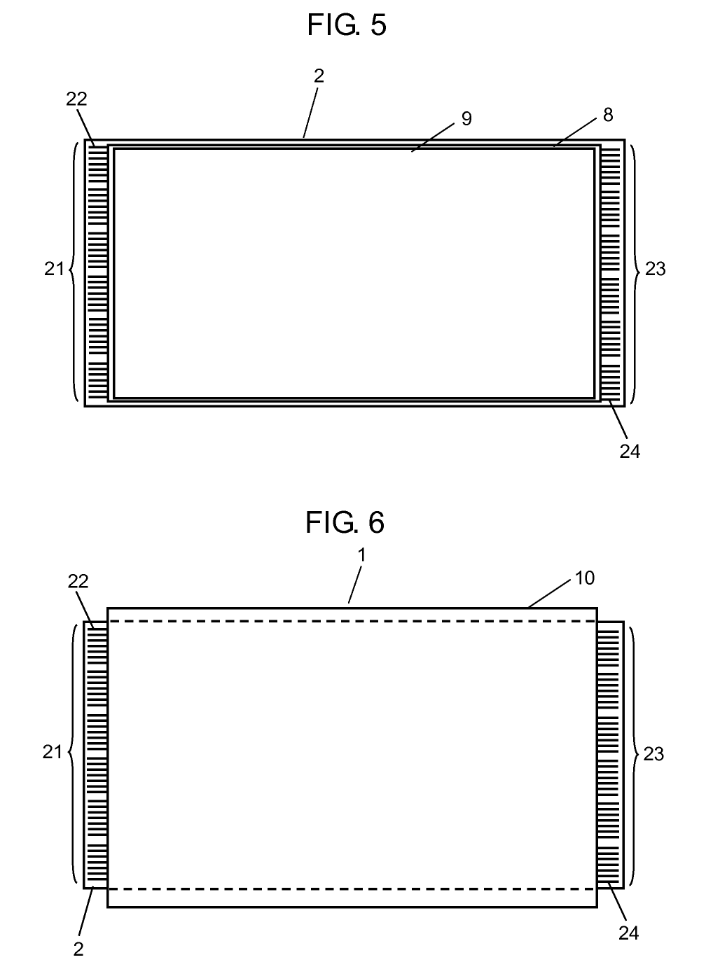

In addition, as shown in FIG. 5, when scan electrode 4 and sustain electrode 5 are formed, scan electrode side interconnect part 21 and sustain electrode side interconnect part 23 are formed at the same time. Scan electrode side interconnect part 21 and sustain electrode side interconnect part 23 are each formed in a region which is not covered with dielectric layer 8 and protective layer 9. A plurality of scan electrode terminals 22 to transmit a signal from a circuit substrate to scan electrode 4 is formed in scan electrode side interconnect part 21. A plurality of sustain electrode terminals 24 to transmit a signal from the circuit substrate to sustain electrode 5 is formed in sustain electrode side interconnect part 23.

Then, in dielectric layer forming step S12, dielectric layer 8 is formed. As a material of dielectric layer 8, a dielectric paste containing a dielectric glass frit, a resin, and a solvent is used. First, the dielectric paste is applied onto front glass substrate 3 by die-coating so as to have a predetermined thickness to cover scan electrode 4, sustain electrode 5, and black stripe 7. Then, the solvent is removed from the dielectric paste in a furnace. Finally, the dielectric paste is fired at a predetermined temperature in the furnace. That is, the resin is removed from the dielectric paste. In addition, the dielectric glass frit melts. The molten dielectric glass frit becomes glass after fired. Through step S12, dielectric layer 8 is formed. Here, the dielectric paste may be applied by screen printing, or spin-coating other than the die-coating. In addition, a film used as dielectric layer 8 may be formed by CVD (Chemical Vapor Deposition) without using the dielectric paste. Dielectric layer 8 will be described below in detail.

Then, in protective layer forming step S13, protective layer 9 is formed on dielectric layer 8. Protective layer includes base film 91 and aggregated particles 92 dispersed on base film 91. Base film 91 contains at least two kinds of metal oxides. A detail of protective layer 9 and a detail of protective layer forming step S13 will be described later.

Then, in sputtering step S14, a surface of protective layer 9 is sputtered. When the surface of protective layer 9 is sputtered, a concentration ratio of the metal oxide in the surface of protective layer 9 is changed. A detail of sputtering step S14 will be described later.

Through above steps S11 to S14, scan electrode 4, sustain electrode 5, black strip 7, dielectric layer 8, and protective layer 9 are formed on front glass substrate 3, whereby front plate 2 is completed.

Then, a description will be made of rear plate producing step S21. Data electrode 12 is formed on rear glass substrate 11 by photolithography. As a material of data electrode 12, a data electrode paste containing Ag to ensure conductivity, a glass frit to bind Ag, a photosensitive resin, and a solvent is used. First, the data electrode paste is applied onto rear glass substrate 11 by screen printing or the like so as to have a predetermined thickness. Then, the solvent is removed from the data electrode paste in a furnace. Then, the data electrode paste is exposed with a photomask having a predetermined pattern put thereon. Then, the data electrode paste is developed, whereby a data electrode pattern is formed. Finally, the data electrode pattern is fired at a predetermined temperature in the furnace. That is, the photosensitive resin is removed from the data electrode pattern. In addition, the glass frit melts in the data electrode pattern. The molten glass frit becomes glass after fired. Through the above steps, data electrode 12 is formed. Here, the data electrode paste may be applied by sputtering, vapor deposition or the like other than the screen printing.

Then, base dielectric layer 13 is formed. As a material of base dielectric layer 13, a base dielectric paste containing a dielectric glass frit, a resin, and a solvent is used. First, the base dielectric paste is applied onto rear glass substrate 11 having data electrode 12 by screen printing or the like so as to have a predetermined thickness and to cover data electrode 12. Then, the solvent is removed from the base dielectric paste in a furnace. Finally, the base dielectric paste is fired at a predetermined temperature in the furnace. That is, the resin is removed from the base dielectric paste. In addition, the dielectric glass frits melts. The molten glass frit becomes glass after fired. Through the above steps, base dielectric layer 13 is formed. Here, the base dielectric paste may be applied by die-coating or spin-coating other than the screen printing. In addition, a film used as base dielectric layer 13 may be formed by CVD without using the base dielectric paste.

Then, barrier rib 14 is formed by photolithography. As a material of barrier rib 14, a barrier rib paste containing a filler, a glass frit to bind the filler, a photosensitive resin, and a solvent is used. First, the barrier rib paste is applied onto base dielectric layer 13 by die-coating or the like so as to have a predetermined thickness. Then, the solvent is removed from the barrier rib paste in a furnace. Next, the barrier rib paste is exposed with a photomask having a predetermined pattern put thereon. Then, the barrier rib paste is developed and a barrier rib pattern is formed. Finally, the barrier rib pattern is fired at a predetermined temperature in the furnace. That is, the photosensitive resin is removed from the barrier rib pattern. In addition, the glass frit melts in the barrier rib pattern. The molten glass frit becomes glass after fired. Through the above steps, barrier rib 14 is formed. Here, sandblasting or the like may be used instead of the photolithography.

Then, phosphor layer 15 is formed. As a material of phosphor layer 15, a phosphor paste containing a phosphor, a binder, a solvent and the like is used. First, the phosphor paste is applied onto base dielectric layer 13 provided between adjacent barrier ribs 14 and onto the side surface of barrier rib 14 by dispensing, so as to have a predetermined thickness. Then, the solvent is removed from the phosphor paste in a furnace. Finally, the phosphor paste is fired at a predetermined temperature in the furnace. That is, the resin is removed from the phosphor paste. Through the above steps, phosphor layer 15 is formed. Here, screen printing, ink-jet printing or the like may be used instead of the dispensing.

Through rear plate producing step S21, rear plate 10 having the predetermined component on rear glass substrate 11 is completed.

Then, in frit applying step S22, a sealing material (not shown) is applied to a periphery of rear plate 10 by dispersing. As a material of the sealing material (not shown), a sealing paste containing a glass frit, a binder, a solvent and the like is used. Then, the solvent is removed from the sealing paste in a furnace.

Then, front plate 2 and rear plate 10 are assembled. In aligning step S31, front plate 2 and rear plate 10 are oppositely arranged so that display electrode 6 intersects with data electrode 12. As shown in FIG. 6, according to PDP 1, each of scan electrode side interconnect part 21 and sustain electrode side interconnect part 23 projects outward when viewed from the side of rear plate 10.

Then, in sealing and exhausting step S32, peripheries of front plate 2 and rear plate 10 are sealed with the glass frit, and discharge space 16 is exhausted.

Finally, in discharge gas supplying step S33, a discharge gas containing Ne, Xe or the like is sealed in discharge space 16.

Finally, aging step S34 is performed because assembled PDP 1 is high in sustain voltage in general and the discharge itself is unstable. Through aging step S34, discharge characteristics of PDP 1 become uniform in the step for producing PDP 1. In addition, the discharge characteristics of PDP 1 become stable.

Thus, PDP 1 is completed.

### 3. Detail of Dielectric Layer

Hereinafter, dielectric layer 8 will be described in detail. Dielectric layer 8 is composed of first dielectric layer 81 and second dielectric layer 82. A dielectric material of first dielectric layer 81 contains 20 wt. % to 40 wt. % of a dibismuth trioxide (Bi₂O₃), 0.5 wt. % to 12 wt. % of at least one component selected from a group consisting of a calcium oxide (CaO), a strontium oxide (SrO), and a barium oxide (BaO), and 0.1 wt. % to 7 wt. % of at least one component selected from a group consisting of a molybdenum trioxide (MoO₃), a tungsten trioxide (WO₃), a cerium dioxide (CeO₂), and a manganese dioxide (MnO₂).

In addition, instead of the group composed of MoO₃, WO₃, CeO₂, and MnO₂, it may contain 0.1 wt. % to 7 wt. % of at least one component selected from a group consisting of a copper oxide (CuO), a dichrome trioxide (Cr₂O₃), a dicobalt trioxide (CO₂O₃), a divanadium heptaoxide (V₂O₇), and a diantimony trioxide (Sb₂O₃).

In addition, as a component other than the above components, it may contain 0 wt. % to 40 wt. % of ZnO, 0 wt. % to 35 wt. % of diboron trioxide (B₂O₃), 0 wt. % to 15 wt. % of silicon dioxide (SiO₂), and 0 wt. % to 10 wt. % of dialuminum trioxide (Al₂O₃), as a component not containing a zinc component.

The dielectric material is ground by wet jet milling or ball milling so that its average grain diameter becomes 0.5 μm to 2.5 μm, whereby dielectric material powder is produced. Then, 55 wt. % to 70 wt. % of this dielectric material powder and 30 wt. % to 45 wt. % of a binder component are kneaded well with three rolls, whereby a first dielectric layer paste to be subjected to die-coating or printing is completed.

The binder component is ethyl cellulose, terpineol containing 1 wt. % to 20 wt. % of an acrylic resin, or butyl carbitol acetate. In addition, in the paste, if needed, dioctyl phthalate, dibutyl phthalate, triphenyl phosphate, or tributyl phosphate may be added as a plasticizer. In addition, glycerol monooleate, sorbitan sesquioleate, homogenol (produced by Kao Corporation), or alkyl aryl group ester phosphate may be added as a dispersant. When the dispersant is added, printing characteristics are improved.

The first dielectric layer paste covers display electrode 6, and is printed on front glass substrate 3 by die-coating or screen printing. The printed first dielectric layer paste is dried and fired at a temperature of 575° C. to 590° C. which is a little higher than a softening point of the dielectric material, whereby first dielectric layer 81 is formed.

Next, second dielectric layer 82 will be described. A dielectric material of second dielectric layer 82 contains 11 wt. % to 20 wt. % of Bi₂O₃, 1.6 wt. % to 21 wt. % of at least one component selected from a group consisting of CaO, SrO, and BaO, and 0.1 wt. % to 7 wt. % of at least one component selected from a group consisting of MoO₃, WO3, and CeO₂.

In addition, instead of MoO₃, WO₃, and CeO₂, it may contain 0.1 wt. % to 7 wt. % of at least one component selected from a group consisting of CuO, Cr₂O₃, CO₂O₃, V₂O₇, Sb₂O₃, and MnO₂.

In addition, as a component other than the above components, it may contain 0 wt. % to 40 wt. % of ZnO, 0 wt. % to 35 wt. % of B₂O₃, 0 wt. % to 15 wt. % of SiO₂, and 0 wt. % to 10 wt. % of Al₂O₃, as a component not containing a zinc component.

The dielectric material is ground by wet jet milling or ball milling so that its average grain diameter becomes 0.5 μm to 2.5 μm, whereby dielectric material powder is produced. Then, 55 wt. % to 70 wt. % of this dielectric material powder and 30 wt. % to 45 wt. % of a binder component are kneaded well with three rolls, whereby a second dielectric layer paste to be subjected to die-coating or printing is completed.

The binder component is ethyl cellulose, terpineol containing 1 wt. % to 20 wt. % of an acrylic resin, or butyl carbitol acetate. In addition, in the paste, if needed, dioctyl phthalate, dibutyl phthalate, triphenyl phosphate, or tributyl phosphate may be added as a plasticizer. In addition, glycerol monooleate, sorbitan sesquioleate, homogenol (produced by Kao Corporation), or alkyl aryl group ester phosphate may be added as a dispersant. When the dispersant is added, printing characteristics are improved.

The second dielectric layer paste is printed on first dielectric layer 81 by die-coating or screen printing. The printed second dielectric layer paste is dried and fired at a temperature of 550° C. to 590° C. which is a little higher than the softening point of the dielectric material, whereby second dielectric layer 82 is formed.

In addition, a film thickness of dielectric layer 8 is preferably 41 μm or less, combining thicknesses of first dielectric layer 81 and second dielectric layer 82, to ensure visible light transmission.

First dielectric layer 81 contains 20 wt. % to 40 wt. % of Bi₂O₃ which is higher than that of Bi₂O₃ contained in second dielectric layer 82, in order to prevent a reaction with Ag of bus electrodes 4b and 5b. Thus, since visible light transmission of first dielectric layer 81 is lower than visible light transmission of second dielectric layer 82, a film thickness of first dielectric layer 81 is formed to be smaller than a film thickness of second dielectric layer 82.

When a content of Bi₂O₃ of second dielectric layer 82 is 11 wt. % or less, color is not likely to be generated, but air bubbles are likely to be generated in second dielectric layer 82. Therefore, it is not preferable that the content of Bi₂O₃ is less than 11 wt. %. Meanwhile, when the content of Bi₂O₃ exceeds 40 wt. %, the color is likely to be generated, so that the visible light transmission is lowered. Therefore, it is not preferable that the content of Bi₂O₃ exceeds 40 wt. %.

In addition, as the film thickness of dielectric layer 8 decreases, brightness is improved and a discharge voltage is reduced. Therefore, the film thickness is preferably set to be smaller to the extent that a breakdown voltage is not lowered.

In view of the above description, according to this embodiment, the film thickness of dielectric layer 8 is set at 41 μm or less, in which first dielectric layer 81 is 5 μm to 15 μm in thickness, and second dielectric layer 82 is 20 μm to 36 μm in thickness.

According to PDP 1 produced as described above, it has been confirmed that dielectric layer 8 can prevent a coloring phenomenon (change into yellow) from occurring on front glass substrate 3, and air bubbles from being generated in dielectric layer 8, and is superior in breakdown voltage performance even when the Ag material is used in display electrode 6.

Next, consideration is given to a reason why the change into yellow and generation of the air bubbles are prevented in first dielectric layer 81 by the dielectric material, in PDP 1 according to this embodiment. That is, it is known that when MoO₃, or WO3 is added into dielectric glass containing Bi₂O₃, a compound such as Ag₂MoO₄, Ag₂Mo₂O₇, Ag₂Mo₄O₁₃, Ag₂WO₄, Ag₂W₂O₇, or Ag₂W₄O₁₃ is likely to be generated at a low temperature of 580° C. or less. According to this embodiment, since the firing temperature of dielectric layer 8 is 550° C. to 590° C., silver ions (Ag⁺) diffused in dielectric layer 8 during the firing process react with MoO₃, WO₃, CeO₂, or MnO₂ in dielectric layer 8, generate a stable compound, and are stabilized. That is, since the Ag⁺ are stabilized without being reduced, they are not aggregated and do not generate colloid. Therefore, since Ag⁺ is stabilized, oxygen generation due to the colloid of Ag is reduced, so that the generation of the air bubbles is reduced in dielectric layer 8.

Meanwhile, in order to efficiently provide the above effect, the content of MoO₃, WO₃, CeO₂, or MnO₂ is preferably 0.1 wt. % or more, or more preferably 0.1 wt. % to 7 wt. %, in the dielectric glass containing Bi₂O₃. Here, when the content is less than 0.1 wt. %, the change into yellow is less prevented, and when the content exceeds 7 wt. %, the glass is uncomfortably colored.

That is, according to dielectric layer 8 of PDP 1 in this embodiment, first dielectric layer 81 which is in contact with bus electrodes 4b and 5b composed of the Ag material prevents the change into yellow and air bubble generation, and second dielectric layer 82 provided on first dielectric layer 81 achieves the high light transmission. As a result, dielectric layer 8, as a whole, can prevent the air bubbles and change into yellow from being generated and achieve high transmission in the PDP.

### 4. Detail of Protective Layer

Protective layer 9 includes base film 91 serving as the base layer and aggregated particles 92. Base film 91 includes at least a first metal oxide and a second metal oxide. The first metal oxide and the second metal oxide are composed of two kinds of components selected from a group consisting of MgO, CaO, SrO and BaO. In addition, base film 91 has at least one peak through an X-ray diffraction analysis. This peak exists between a first peak of the first metal oxide through an X-ray diffraction analysis and a second peak of the second metal oxide through an X-ray diffraction analysis. The first peak and the second peak show the same surface orientation as a surface orientation shown by the peak of base film 91.

### 4-1. Detail of Base Film

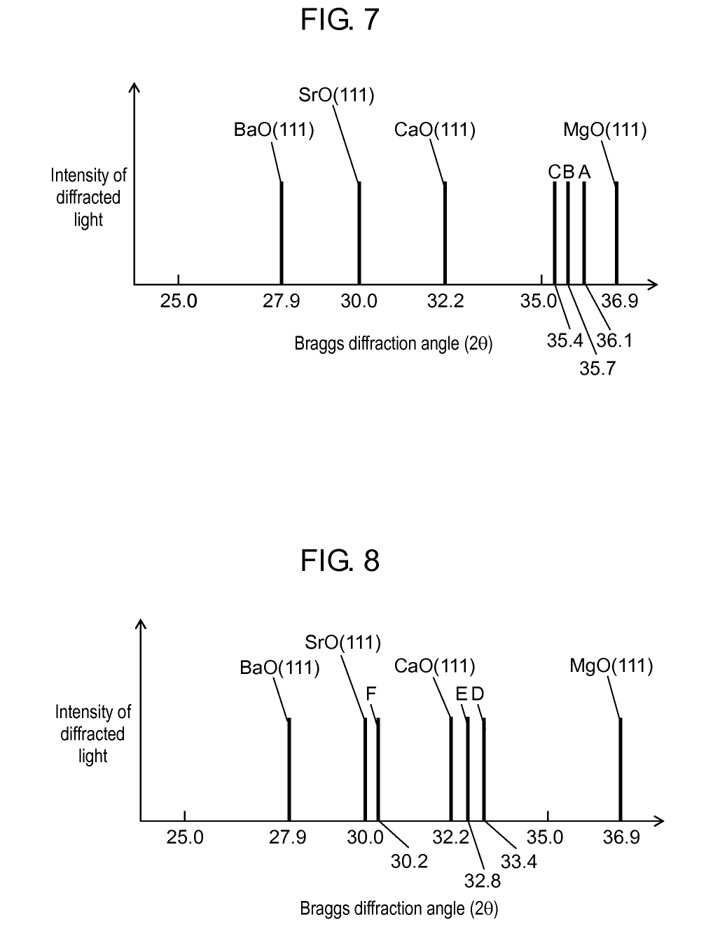

FIG. 7 shows an X-ray diffraction result on the surface of base film 91 composing the protective layer 9 of PDP 1 according to this embodiment. In addition, FIG. 7 also shows a result of X-ray diffraction analyses of MgO simple substance, CaO simple substance, SrO simple substance, and BaO simple substance.

Referring to FIG. 7, a horizontal axis shows a Braggs diffraction angle (2θ), and a vertical axis shows intensity of an X-ray diffraction wave. A unit of the diffraction angle is represented by a degree in a case where one circle is 360 degrees, and the intensity is represented by an arbitrary unit. A crystal orientation as a specific orientation is shown in parentheses.

As shown in FIG. 7, in the surface orientation of (111), the CaO simple substance has a peak at a diffraction angle of 32.2 degrees. The MgO simple substance has a peak at a diffraction angle of 36.9 degrees. The SrO simple substance has a peak at a diffraction angle of 30.0 degrees. The BaO simple substance has a peak at a diffraction angle of 27.9 degrees.

According to PDP 1 in this embodiment, base film 91 of protective layer 9 contains at least two metal oxides selected from the group consisting of MgO, CaO, SrO, and BaO.

FIG. 7 shows the X-ray diffraction result in a case where the two simple substance components compose base film 91. A point A shows an X-ray diffraction result of base film 91 composed of the MgO simple substance and the CaO simple substance as the simple substance components. A point B shows an X-ray diffraction result of base film 91 composed of the MgO simple substance and the SrO simple substance as the simple substance components. A point C shows an X-ray diffraction result of base film 91 composed of the MgO simple substance and the BaO simple substance as the simple substance components.

As shown in FIG. 7, in the surface orientation of (111), the point A has a peak at a diffraction angle of 36.1 degrees. The MgO simple substance serving as the first metal oxide has the peak at the diffraction angle of 36.9 degrees. The CaO simple substance serving as the second metal oxide has the peak at the diffraction angle of 32.2 degrees. That is, the peak of the point D exists between the peak of the MgO simple substance and the peak of the SrO simple substance. Similarly, a peak of the point E is provided at a diffraction angle of 32.8 degrees, and it exists between the peak of the MgO simple substance serving as the first metal oxide, and the peak of the BaO simple substance serving as the second metal oxide. A peak of the point F is provided at a diffraction angle of 30.2 degrees, and it exists between the peak of the CaO simple substance serving as the first metal oxide and the peak of the BaO simple substance serving as the second metal oxide.

In addition, FIG. 8 shows an X-ray diffraction result in a case where the three or more simple substances compose base film 91. A point D shows an X-ray diffraction result of base film 91 composed of MgO, CaO, and SrO as the simple substances. A point E shows an X-ray diffraction result of base film 91 composed of MgO, CaO, and BaO as the simple substances. A point F shows an X-ray diffraction result of base film 91 composed of CaO, SrO, and BaO as the simple substances.

As shown in FIG. 8, in the surface orientation of (111), the point D has a peak at a diffraction angle of 33.4 degrees. The MgO simple substance serving as the first metal oxide has the peak at the diffraction angle of 36.9 degrees. The SrO simple substance serving as the second metal oxide has the peak at the diffraction angle of 30.0 degrees. That is, the peak of the point A exists between the peak of the MgO simple substance and the peak of the CaO simple substance. Similarly, a peak of the point E is provided at a diffraction angle of 32.8 degrees, and it exists between the peak of the MgO simple substance serving as the first metal oxide, and the peak of the BaO simple substance serving as the second metal oxide. The peak of the point F is provided at the diffraction angle of 30.2 degrees and it exists between the peak of the MgO simple substance serving as the first metal oxide, and the peak of the BaO simple substance serving as the second metal oxide.

Thus, base film 91 of PDP 1 in this embodiment includes at least the first metal oxide and the second metal oxide. In addition, base film 91 has at least one peak through the X-ray diffraction analysis. This peak exists between the first peak of the first metal oxide through an X-ray diffraction analysis and the second peak of the second metal oxide through an X-ray diffraction analysis. The first peak and the second peak show the same surface orientation as the surface orientation shown by the peak of base film 91. The first metal oxide and the second metal oxide are composed of two kinds of components selected from the group consisting of MgO, CaO, SrO, and BaO.

In addition, the description has been made using the crystal surface orientation of (111) in the above, but even when another surface orientation is used, the position of the peak of the metal oxide is the same as above.

Depths of CaO, SrO, and BaO from a vacuum level are smaller than that of MgO. Therefore, when PDP 1 is driven, it is considered that the number of electrons discharged due to the Auger effect while the electrons existing in energy levels of CaO, SrO, and BaO are moved to the ground state of the Xe ion is greater than that of the electrons which are moved from an energy level of MgO.

In addition, as described above, the peak of base film 91 in this embodiment exists between the peak of the first metal oxide and the peak of the second metal oxide. That is, it is considered that the energy level of base film 91 exists between the simple metal oxides, and the number of electrons discharged due to the Auger effect is greater than that of the electrons which are moved from the energy level of MgO.

As a result, compared to the MgO simple substance, base film 91 can show preferable secondary electron emission characteristics, so that it can reduce a sustain voltage. Therefore, when Xe partial pressure is increased as a discharge gas to enhance the brightness especially, the discharge voltage is lowered, and high-brightness and low-voltage PDP 1 can be realized.

Table 1 shows a result of a sustain voltage obtained when a mixture gas (Xe, 15%) of Xe and Ne is sealed at 60 kPa, while changing the composition of base film 91, in PDP 1 in this embodiment.

### [Table 1]

In addition, the sustain voltage in Table 1 is represented by a relative value when a value of a comparative example is set at “100”. Base film 91 of sample A is composed of MgO and CaO. Base film 91 of sample B is composed of MgO and SrO. Base film 91 of sample C is composed of MgO and BaO. Base film 91 of sample D is composed of MgO, CaO, and SrO. Base film 91 of sample E is composed of MgO, CaO, and BaO. In addition, as for the comparative example, base film 91 is formed of the MgO simple substance.

When the partial pressure of Xe of the discharge gas is increased from 10% to 15%, the brightness is increased by about 30%, but the sustain voltage is increased by about 10%, in the comparative example in which base film 91 is composed of MgO simple substance.

Meanwhile, according to the PDP in this embodiment, the sustain voltages in sample A, sample B, sample C, sample D, and sample E can be all reduced by about 10% to 20% compared to the comparative example. Therefore, they can be a sustain voltage within a normal operation range, so that the PDP can be high in brightness and driven at low voltage.

In addition, CaO, SrO, or BaO is high in reactivity when it is provided as the simple substance, so that it is likely to react with the impurity, and the electron emission performance is problematically lowered. However, according to this embodiment, since the metal oxides are combined, a crystal structure is provided so that the reactivity is lowered, the impurity is hardly mixed, and an oxygen defect is small. Therefore, the electrons are prevented from being emitted excessively when the PDP is driven, and in addition to both effects of the low voltage drive and the secondary electron emission performance, an effect of appropriate charge retaining characteristics can be provided. These charge retaining characteristics are especially very effective when under the condition that wall charges stored in an initializing period are retained, an address discharge is surely performed while preventing an address defect during an address period.

### 4-2. Detail of Aggregated Particle

Next, aggregated particle 92 provided on base film 91 according to this embodiment will be described in detail.

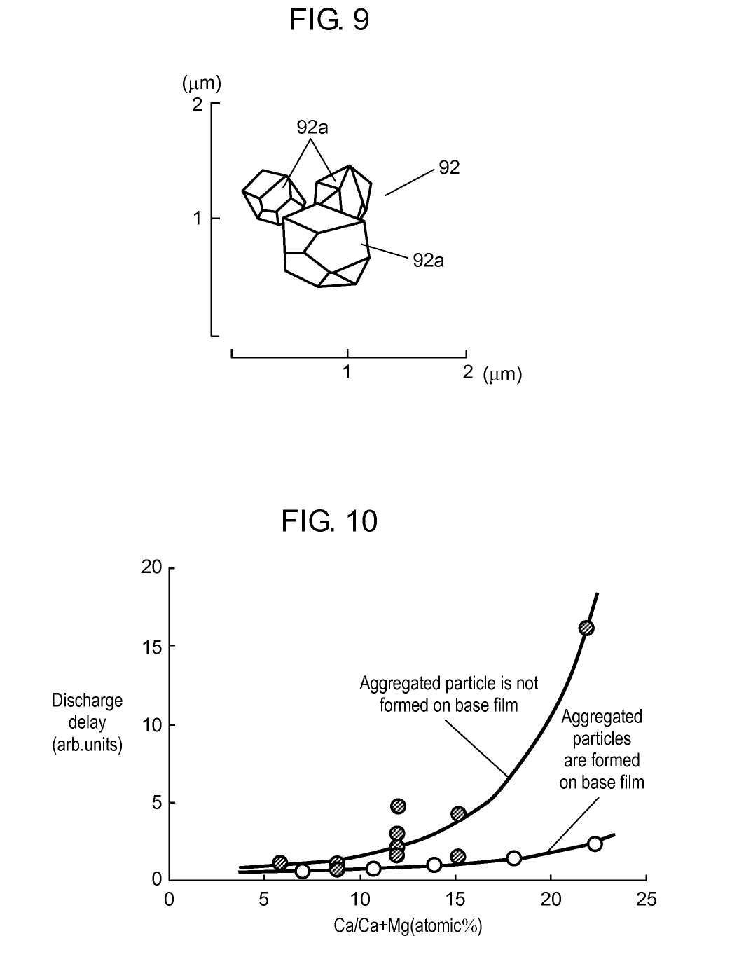

As shown in FIG. 9, aggregated particle 92 is formed of aggregated crystal particles 92a of MgO. Its shape can be confirmed under a scanning type electron microscope (SEM). According to this embodiment, the aggregated particles 92 are arranged so as to be dispersed over the whole surface of base film 91.

Aggregated particle 92 has an average particle diameter of 0.9 μm to 2.5 μm. In this embodiment, the average particle diameter means a volume accumulation average diameter (D50). In addition, the average particle diameter is measured by a laser diffraction type particle size distribution measurement device MT-3300 (produced by Nikkiso Co., Ltd.).

Aggregated particles 92 are not connected by strong bonding force as a solid. Aggregated particle 92 is composed of a plurality of primary particles bonded by static electricity or van der Waals' force. In addition, the aggregated particle 92 is partially or wholly decomposed to the state of the primary particle by external force such as an ultrasonic wave. Aggregated particle 92 has the average particle diameter of about 1 μm, and crystal particle 92a is in the form of a polyhedron having seven or more faces such as a tetradodecahedron or dodecahedron. In addition, crystal particle 92a can be produced by gas phase synthesis or precursor firing which will be described below.

According to the gas phase synthesis, a magnesium (Mg) metal material having purity of 99.9% or more is heated in an atmosphere filled with an inert gas. Then, it is heated in an atmosphere added with a little amount of oxygen, so that Mg is directly oxidized. Thus, crystal particle 92a of MgO is produced.

Meanwhile, according to the precursor firing, crystal particle 92a is produced by a following method. According to the precursor firing, a precursor of MgO is uniformly fired at a high temperature of 700° C. or more. Then, the fired MgO is gradually cooled down, whereby crystal particle 92a of MgO is produced. The precursor may be a compound composed of at least one kind of components selected from a group consisting of magnesium alkoxide (Mg(OR)₂), magnesium acetylacetone (Mg(acac)₂), magnesium hydroxide (Mg(OH)₂), magnesium carbonate (MgCO₂), magnesium chloride (MgCl₂), magnesium sulfate (MgSO₄), magnesium nitrate (Mg(NO₃)₂), and magnesium oxalate (MgC₂O₄).

In addition, depending on the selected compound, the compound takes the form of a hydrate in a normal state, and the hydrate may be used. The compound is adjusted such that purity of MgO obtained after fired is to be 99.95% or more, or preferably 99.98% or more. When a certain amount or more of an impurity element of alkali metal such as B, Si, Fe, or Al is mixed in the compound, the particles are unnecessarily bonded to each other or fired during the heat treatment, and in this case, it is hard to obtain crystal particle 92a of MgO having high crystallinity. Thus, it is necessary to previously adjust the precursor by removing the impurity element. By adjusting a firing temperature or a firing atmosphere in the precursor firing, the particle diameter can be controlled. The firing temperature can be selected within a range of 700° C. to 1500° C. When the firing temperature is 1000° C. or more, a primary particle diameter can be controlled to be 0.3 to 2 μm. A plurality of primary particles of crystal particles 92a is aggregated to each other while being generated by the precursor firing to become aggregated particle 92.

It has been confirmed that aggregated particle 92 of MgO provides an effect to prevent a discharge delay mainly generated in the address discharge, and an effect to improve temperature dependency of the discharge delay, through experiments by the present inventor. Thus, according to this embodiment, since aggregated particle 92 has a feature superior in initial electron emission characteristics, compared to base film 91, it is arranged as a part to supply an initial electron required when a discharge pulse rises.

It is considered that the discharge delay is mainly caused by deficiency in amount of initial electrons emitted from the surface of base film 91 to discharge space 16 to serve as a trigger at the start of discharge. Thus, aggregated particles 92 of MgO are dispersed on the surface of base film 91 in order to contribute to stable supply of the initial electrons to discharge space 16. Thus, the electrons sufficiently exist in discharge space 16 when the discharge pulse rises, so that the problem of the discharge delay can be solved. Therefore, due to the initial electron emission characteristics, high-definition PDP 1 is also superior in discharge responsiveness and can be driven at high speed. In addition, when aggregated particles 92 of the metal oxide are arranged on the surface of base film 91, in addition to the main effect to prevent the discharge delay in the address discharge, the effect to improve the temperature dependency of the discharge delay is provided.

As described above, PDP 1 in this embodiment includes base film 91 which provides both effects of the low voltage driving and the charge retention, and aggregated particles 92 of MgO which provides the effect of the prevention of the discharge delay, so that the high-definition PDP can be driven at high speed and low voltage in PDP 1 as a whole, and high-grade image display performance can be realized by preventing a lighting defect.

### 4-3. Experiment 1

FIG. 10 is a view showing a relationship between a discharge delay generated when base film 91 is composed of MgO and CaO among PDPs 1 according to this embodiment, and a concentration of calcium (Ca) in protective layer 9. Thus, base film 91 is composed of MgO and CaO, and base film 91 has the peak between the diffraction angle at the peak of MgO and the diffraction angle at the peak of CaO, through an X-ray diffraction analysis.

In addition, FIG. 10 shows a case where protective layer 9 is only composed of base film 91, and the case where aggregated particles 92 are arranged on base film 91, and the discharge delay is represented, based on a case where Ca is not contained in base film 91.

As can be clearly understood from FIG. 10, according to the case where only base film 91 is provided, and the case where aggregated particles 92 are arranged on base film 91, while as the Ca concentration increases, the discharge delay increases in the case where only base film 91 is provided, the discharge delay can be considerably prevented from increasing and the discharge delay hardly changes even when the Ca concentration increases in the case where aggregated particles 92 are arranged on base film 91.

### 4-4. Experiment 2

Next, a description will be made of a result of an experiment performed to confirm the effect of PDP 1 having protective layer 9 according to this embodiment.

First, PDPs 1 having different protective layers 9 are produced experimentally. Sample 1 is PDP 1 in which protective layer 9 is only formed of MgO. Sample 2 is PDP 1 in which protective layer 9 is formed of MgO doped with an impurity such as Al or Si. Sample 3 is PDP 1 in which only primary particles of crystal particles 92a formed of MgO are dispersed and attached on protective layer 9 formed of MgO.

Meanwhile, sample 4 is PDP 1 according to this embodiment. Sample 4 is PDP 1 in which aggregated particles 92 composed of aggregated crystal particles 92a formed of MgO and having the same particle diameter are dispersed all over base film 91 formed of MgO. Sample A described above is used for protective layer 9. That is, protective layer 9 is composed of base film 91 composed of MgO and CaO, and aggregated particles 92 composed of aggregated crystal particles 92a uniformly distributed all over base film 91. In addition, base film 91 has the peak between the peak of the first metal oxide and the peak of the second metal oxide of base film 91, through the X-ray diffraction analysis of the surface of base film 91. That is, the first metal oxide is MgO, and the second metal oxide is CaO. Thus, the diffraction angle of the peak of MgO is 36.9 degrees, the diffraction angle of the peak of CaO is 32.2 degrees, and the diffraction angle of the peak of base film 91 is 36.1 degrees.

Electron emission performance and charge retention performance are measured on PDPs 1 having four kinds of protective layers.

In addition, as for the electron emission performance, as its value increases, an electron emission amount increases. The electron emission performance is expressed by an initial electron emission amount determined by a surface state of the discharge, a gas kind, and its state. The initial electron emission amount can be obtained by measuring an electronic current amount emitted from the surface when the surface is irradiated with an ion or electron beam. However, it is difficult to make a measurement by a nondestructive way. Thus, a method disclosed in Unexamined Japanese Patent Publication No. 2007-48733 is used. That is, among the delay times at the time of discharge, a value which is an indication of ease of discharge generation, called a statistical delay time is measured. When an inverse number of the statistical delay time is integrated, an obtained value linearly corresponds to the emission amount of the initial electrons. The delay time at the time of discharge corresponds to a time from rising of an address discharge pulse until the address discharge is generated later. The discharge delay is supposed to be mainly caused because the initial electron serving as the trigger to generate the address discharge is not easily emitted from the protective layer surface to the discharge space.

The charge retention performance is expressed, as its index, by a voltage value of a voltage (hereinafter, referred to as the Vscn lighting voltage) applied to the scan electrode to prevent electron emission phenomenon in PDP 1. That is, the lower the Vscn lighting voltage is, the higher the charge retention ability is. When the Vscn lighting voltage is low, the PDP can be driven at a low voltage. Thus, a component which is low in breakdown voltage and low in capacity can be used as a power supply or an electric component. As for a current product, an element having a breakdown voltage as low as 150 V is used as a semiconductor switching element such as a MOSFET provided to sequentially apply the scan voltage to the panel. The Vscn lighting voltage is preferably suppressed to 120 V or lower in view of a variation due to temperature.

As can be clearly understood from FIG. 11, as for sample 4, the Vscn lighting voltage can be 120 V or less in the evaluation of the charge retention performance, and the electron emission performance is considerably preferable as compared with sample 1 in which the protective layer is only composed of MgO.

In general, the electron emission ability of the protective layer of the PDP contradicts with the charge retention ability thereof. The electron emission performance can be improved by changing a condition for forming the protective layer, or doping an impurity such as Al, Si, or Ba in the protective layer in a film formation process. However, the Vscn lighting voltage also rises as an adverse effect.

According to the PDP having protective layer 9 in this embodiment, the electron emission ability is 8 or more, and as for the charge retention ability, the Vscn lighting voltage is 120 V or less. That is, protective layer 9 can be provided with the electron emission ability and the charge retention ability which can cope with the PDP in which the number of scan lines is great due to high definition, and a cell size tends to be miniaturized.

### 4-5. Experiment 3

Next, a detailed description will be made of the particle diameter of aggregated particle 92 used in protective layer 9 of PDP 1 according to this embodiment. In addition, in the following description, the particle diameter means the average particle diameter, and the average particle diameter means the volume accumulation average diameter (D50).

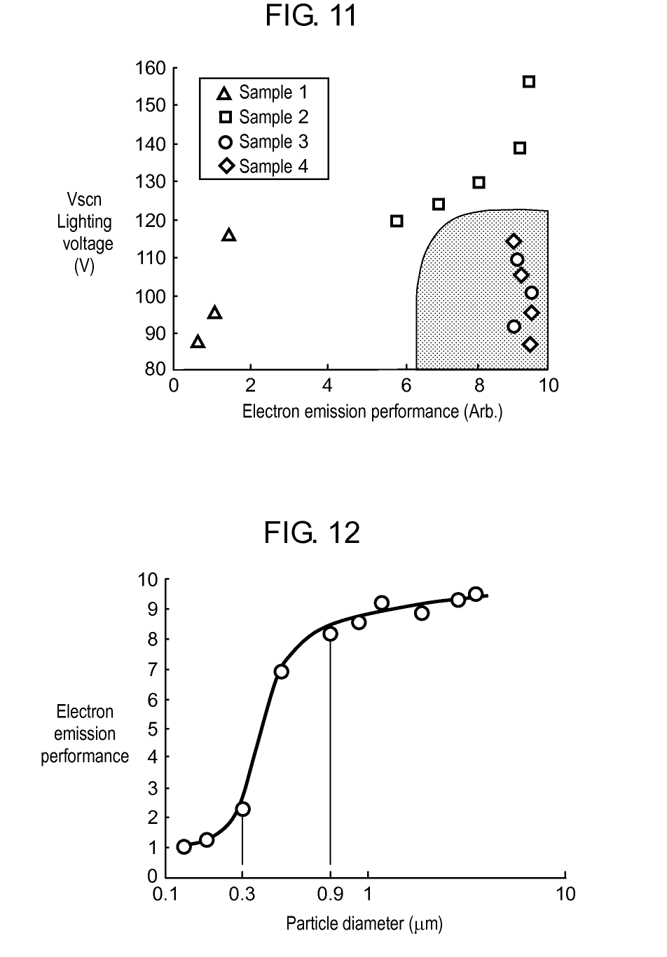

FIG. 12 shows a result of an experiment to examine the electron emission performance of protective layer 9 while changing the average particle diameter of aggregated particle 92 of MgO. In FIG. 12, the average particle diameter of aggregated particle 92 is measured by observing aggregated particle 92 under the SEM.

As shown in FIG. 12, when the average particle diameter is as small as 0.3 μm, the electron emission performance is low, and when it is approximately 0.9 μm or more, the electron emission performance can be high.

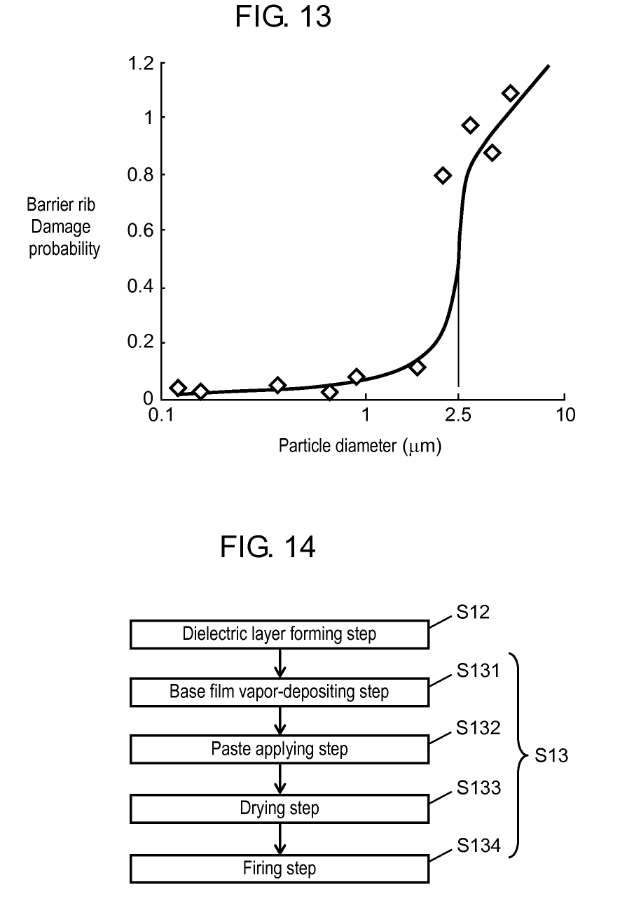

In order to increase the number of emitted electrons in the discharge cell, the number of crystal particles per unit area of protective layer 9 is preferably large. According to an experiment made by the present inventors, when crystal particle 92a exists in a part corresponding to a top of barrier rib 14 which is closely in contact with protective layer 9, it could damage the top of barrier rib 14. In this case, it is found that a material of damaged barrier rib 14 covers the phosphor, so that the corresponding cell is not normally turned on or off. The damage in the barrier rib is not likely to be caused when crystal particle 92a does not exist at the part corresponding to the barrier rib top, so that as the number of attached crystal particles increases, a probability of damage generation of barrier rib 14 becomes high. FIG. 13 shows a result of an experiment to examine the probability of barrier rib damage while changing the average particle diameter of aggregated particle 92. As shown in FIG. 13, when the average particle diameter of aggregated particle 92 is increased to about 2.5 μm, the barrier rib damage probability abruptly becomes high, and when it is smaller than 2.5 μm, the barrier rib damage probability can be suppressed to be relatively low.

As described above, according to PDP 1 having protective layer 9 in this embodiment, the electron emission ability is 8 or more, and as for the charge retention ability, the Vscn lighting voltage is 120 V or less.

In addition, while the description has been made with the MgO particles as crystal particles in the above, the kind of the particle is not limited to MgO because the same effect can be also provided with a crystal particle of a metal oxide such as Sr, Ca, Ba, or Al having high electron emission performance like MgO as other single crystals.

### 5. Detail of Protective Layer Forming Step S13

Next, a description will be made of protective layer forming step S13 in PDP 1 according to this embodiment, with reference to FIG. 14.

As shown in FIG. 14, after dielectric layer forming step S12 for forming dielectric layer 8, protective layer forming step S13 is composed of base film vapor-depositing step S131, paste applying step S132, drying step S133, and firing step S134.

### 5-1. Base Film Vapor-Depositing Step S131

In base film vapor-depositing step S131, base film 91 is formed on dielectric layer 8 by vacuum vapor deposition. A raw material of the vacuum vapor deposition is a pellet of a material of the MgO simple substance, CaO simple substance, SrO simple substance, or BaO simple substance, or a pellet formed by mixing the above materials. Other than the vacuum vapor deposition, a method such as sputtering or ion-plating may be used.

Then, in subsequent paste applying step S132 and drying step S133, film 17 composed of an organic solvent is formed on base film 91 so as to be spread on the whole surface of unfired base film 91. Alternatively, base film 91 may be fired before paste applying step S132.

### 5-2. Paste applying step S132

In paste applying step S132, first, an aggregated particle paste is made as the organic solvent in which aggregated particles 92 are dispersed. Then, the aggregated particle paste is applied onto base film 91, whereby an aggregated particle paste film having an average film thickness of 8 μm to 20 μm is formed. In addition, the method for applying the aggregated particle paste on base film 91 may include screen printing, spraying, spin-coating, die-coating, and slit-coating.

Here, the organic solvent used for producing the aggregated particle paste preferably has high affinity with base film 91 and aggregated particle 92. For example, an organic solvent simple substance such as methoxy methyl butanol, terpineol, propylene glycol, or benzyl alcohol, or their mixed solvent may be used. In addition, the organic solvent may contain a resin. Viscosity of the paste containing the organic solvent is about 20 mPa·s.

Thus, front glass substrate 3 on which the aggregated particle paste has been applied is immediately transferred to drying step S133.

### 5-3. Drying Step S133

In drying step S133, the aggregated particle paste film is dried. Thus, after the organic solvent has been evaporated, aggregated particles 92 are dispersed on base film 91. At this time, the organic solvent is not all evaporated and remains on base film 91. The drying is preferably performed under reduced pressure. More specifically, a pressure in a vacuum chamber is reduced to about 10 Pa in 2 minutes, so that the aggregated particle paste film is dried at high speed. According to this method, convection which is noticeably generated in a case of drying by heating is not generated. Therefore, aggregated particles 92 are more uniformly attached on base film 91. However, as the drying method, the drying by heating may be used, depending on characteristics of the organic solvent.

### 5-4. Firing Step S134

Then, in firing step S134, the organic solvent and the resin remaining on base film 91 are fired, so that the organic solvent is evaporated. Thus, aggregated particles 92 are dispersed on base film 91.

First, after drying step S133, front glass substrate 3 is conveyed to a furnace. Then, the furnace is heated while being exhausted. It is heated until front glass substrate 3 reaches a temperature such as 370° C. Thus, front glass substrate 3 is held at the temperature for 10 to 20 minutes. Thus, the organic solvent is evaporated. After the organic solvent has been evaporated, aggregated particles 92 are dispersed on base film 91. Here, when the organic solvent contains the resin, the resin is also burned.

In addition, in firing step S134, unfired base film 91 formed in base film vapor depositing step S131 is also fired.

According to this method, aggregated particles 92 can be diffused all over base film 91.

### 6. Sputtering Step S14

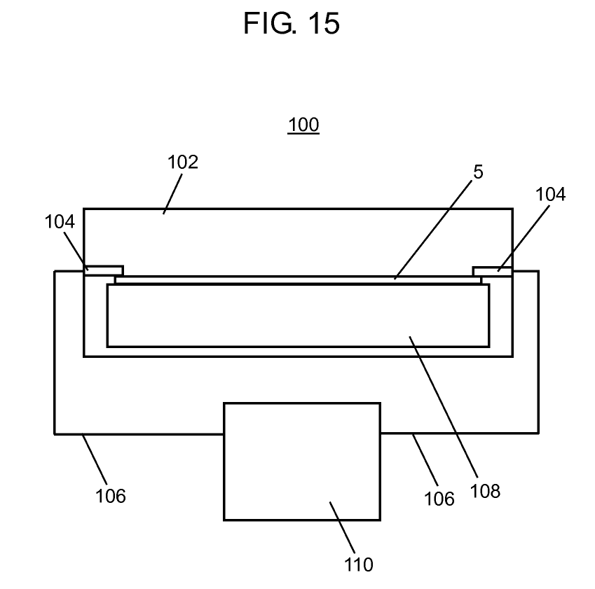

In sputtering step S14, discharge device 100 shown in FIG. 15 may be used. Discharge device 100 includes discharge chamber 102, a plurality of terminal parts 104, cable 106, table 108, and DC power supply 110. Discharge chamber 102 has a gate part (not shown). Front glass substrate 3 is taken in and out through the gate part. Terminal part 104 has a bar-shaped conductive part. Terminal parts 104 are arranged in at least two positions so that they are opposed to each other in discharge chamber 102. Terminal part 104 and DC power supply 110 are electrically connected through cable 106. Table 108 is arranged in discharge chamber 102. Table 108 has a fixing mechanism (not shown). DC power supply 110 includes an LC resonance circuit and can generate a pulse waveform. Furthermore, DC power supply 110 can supply different pulse waveforms to terminal parts 104.

First, front glass substrate 3 in which aggregated particles 92 are attached on base film 91 is set on table 108. Front glass substrate 3 is set with base film 91 side up. Then, sustain electrode terminal 24 shown in FIGS. 5 and 6 is connected to the conductive part of terminal part 104. In addition, scan electrode terminal 22 is connected to the conductive part of terminal part 104.

Then, an inert gas is introduced into discharge chamber 102. More specifically, first, discharge chamber 102 is exhausted from the atmospheric pressure to about 10⁻² Pa by a vacuum pump (not shown). Then, a mixture gas containing 15 vol. % of Xe and 85 vol. % of Ne is introduced into discharge chamber 102 as the inert gas. A pressure in discharge chamber 102 is increased to 60 kPa by the inert gas.

Then, DC power supply 110 generates the pulse waveform. The pulse waveform applied to scan electrode terminal 22 through cable 106 and terminal part 104 is transmitted to scan electrode 4. The pulse waveform applied to sustain electrode terminal 24 through cable 106 and terminal part 104 is transmitted to sustain electrode 5. A phase of the pulse waveform applied to sustain electrode 5 is shifted from that of the pulse waveform applied to scan electrode 4 by a half cycle. However, a cycle and a peak height of the pulse waveform applied to scan electrode 4 are the same as those of the pulse waveform applied to sustain electrode 5. According to this embodiment, DC power supply 110 generates a voltage of 200 V. In addition, the pulse waveform ringed by the LC resonance circuit has a peak height of 260 V and a frequency of 45 kHz.

Surface discharge is generated between sustain electrode 5 to which the pulse waveform has been applied, and scan electrode 4 to which the pulse waveform has been applied. Thus, Xe ion generated by the discharge collides with base film 91 and aggregated particles 92. The surface of protective layer 9 is sputtered by the colliding Xe ion. Due to the sputtering, the concentration ratio of the metal oxide in the surface of protective layer 9 is changed. This is because the metal oxides contained in protective layer 9 have different sputtering rates. In addition, this is because a component of the sputtered protective layer 9 is re-deposited on protective layer 9. Most metal oxides emitted from the surface of base film 91 and aggregated particle 92 are re-deposited on base film 91 and aggregated particle 92. Since the pressure in discharge chamber 102 is increased to the pressure (60 kPa) which is close to the atmospheric pressure, it is considered that the sputtered metal oxides are kicked back by the discharge gas without moving a long distance.

The inventors have measured the concentration ratio of the metal oxide in the surface of the protective layer 9 by X-ray photoelectron spectrometry (XPS). As a measurement device, a scan-type photoelectron spectrometer (produced by ULVAC-PHI, Inc.) is used. A region ranging from an uppermost surface to 10 nm in protective layer 9 is measured by the XPS. A concentration ratio of the metal oxide in the discharge region and a concentration ratio of the metal oxide in the non-discharge region in the surface of protective layer 9 are changed with processing time. Especially, a concentration ratio of the metal oxide in a sputtered region on base film 91 and a concentration ratio of the metal oxide in a non-sputtered region on base film 91 are largely changed with processing time. This is because a new mixture film of the metal oxide having a changed concentration ratio is formed on the surface of protective layer 9. Thus, the concentration ratio of the metal oxide in protective layer 9 comes to equilibrium after a specific processing time, and converges to a specific concentration. After the mixture film has been formed, the mixture film itself is sputtered. Thus, a component of the sputtered mixture film is re-deposited. Thus, it is considered that the concentration of the metal oxide is hardly changed after the specific processing time.

Thus, the concentration ratio of the metal oxide in the surface of protective layer 9 comes to equilibrium after the specific processing time, and a surface composition of protective layer 9 becomes stable.

Since the surface composition of protective layer 9 becomes stable in sputtering step S14, the sustain voltage of PDP 1 is prevented from fluctuating with discharge time. In addition, protective layer 9 previously comes close to be in a state provided after an aging process. Therefore, a time required in aging step S34 is reduced in the method for producing PDP 1.

In addition, a shape of the pulse waveform such as the peak height or the frequency can be accordingly adjusted depending on a pressure and a composition of the inert gas and a distance of a discharge gap. The pulse waveform is not limited to a ringing pulse and may be a rectangular pulse. The frequency of the pulse waveform is set in a range of 5 kHz to 180 kHz. The processing time is preferably set in a range of 10 seconds to 15 minutes. This is because the processing time needs to be at least 10 seconds in order to change the concentration ratio in the surface of protective layer 9. In addition, this is because the concentration ratio of the surface of protective layer 9 comes to equilibrium within 15 minutes of the processing time. As the inert gas, at least one gas selected from a group consisting of a rare gas and nitrogen gas is used. The atmosphere in discharge chamber 102 is preferably in a range of 40 kPa to 90 kPa. This is because the component of sputtered protective layer 9 is re-deposited in this condition.

Thus, since the surface composition of protective layer 9 becomes stable, the sustain voltage of PDP 1 is prevented from fluctuating with discharge time.

By the way, according to a conventional method for producing the PDP, in an aging step, a rectangular wave having a reverse phase is applied between scan electrode 4 and sustain electrode 5. For example, the rectangular wave having a potential difference of about 200 (V) is applied. Thus, the discharge is caused between scan electrode 4 and sustain electrode 5 in discharge space 16. The rectangular wave is applied for about 3 hours.

Meanwhile, according to the method for producing PDP 1 in this embodiment, protective layer 9 comes close to be in the state provided after aging step S34, in sputtering step S14. Therefore, when the rectangular wave having the potential difference similar to the conventional aging step is applied, 1 hour in aging step S34 can be reduced to ⅓ to 1/10 thereof.

Furthermore, protective layer 9 is cleaned in sputtering step S14. A CO series impurity is removed from protective layer 9 by the cleaning. Thus, base film 91 is prevented from being altered, and the sustain voltage is lowered.

### 6-1. Working Example

Thus, PDP 1 has been produced and performance of PDP 1 has been evaluated. Produced PDP 1 is adapted to a 42-inch high-definition television. That is, PDP 1 includes front plate 2, and rear plate 10 arranged so as to be opposed to front plate 2. In addition, the peripheries of front plate 2 and rear plate 10 are sealed with the sealing material. Front plate 2 has display electrode 6, dielectric layer 8, and protective layer 9. Rear plate 10 has data electrode 12, base dielectric layer 13, barrier rib 14, and phosphor layer 15. A neon Ne—Xe series mixture gas containing 15 vol. % of Xe is sealed at an inner pressure of 60 kPa in PDP 1. In addition, a distance between scan electrode 4 and sustain electrode 5, that is, a length of main gap 50 is 80 μm. A height of barrier rib 14 is 120 μm, a gap (cell pitch) between barrier rib 14 and barrier rib 14 is 150 μm.

Base film 91 in a working example and a comparative example is composed of CaO and MgO. In base film vapor-depositing step S131, as a raw material of a vacuum vapor deposition, a pellet provided by mixing 97.1 mol % of MgO and 2.9 mol % of CaO is used. A film thickness of base film 91 is 700 nm. Aggregated particles 92 each composed of crystal particles 92a of MgO are dispersed over the whole surface of base film 91. An average particle diameter of aggregated particle 92 is 1.1 μm. A coverage factor of aggregated particles 92 in the working example and the comparative example is 15.0%.

In the comparative example, sputtering step S14 is not performed. Therefore, a difference in PDP 1 between the working example and the comparative example is that sputtering step S14 is performed or not.

The inventors have measured a concentration of CaO in the surface of protective layer 9 formed over display electrode 6 by the XPS. That is, the sputtered region ranging from the outermost surface to 10 nm in the surface of protective layer 9 is measured. The concentration of CaO in the sputtered region comes to equilibrium after about 15 minutes of processing time, and converges to 16.0 mol %. This is because a new mixture film of CaO and MgO is formed on protective layer 9 in the sputtered region in about 15 minutes of the processing time. The sputtered region is mostly provided over display electrode 6.

In addition, there is an increase in concentration of MgO in the surface of protective layer 9 in a non-sputtered region. This is because a new mixture film is also formed in the non-sputtered region. The mixture film formed in the sputtered region and the mixture film formed in the non-sputtered region are different in concentration ratio of the metal oxide. That is, the concentration ratio of the metal oxide on the surface of protective layer 9 provided over display electrode 6 is different from the concentration ratio in the metal oxide on the surface of protective layer 9 over which display electrode 6 is not formed. In addition, a concentration ratio of the metal oxide in the surface of protective layer 9 in main gap 50 is different from a concentration ratio of the metal oxide in the surface of protective layer 9 in inter-pixel gap 60.

In addition, in base film vapor-depositing step S131, another base film 91 is formed of a pellet containing MgO and CaO having different concentration ratios in another working example and a concentration thereof is similarly measured by the XPS. In a case of a pellet containing 99.3 mol % of MgO, and 0.7 mol % of CaO, a concentration of CaO in a sputtered region converges to 4.3 mol %. In a case of a pellet containing 94.1 mol % of MgO and 5.9 mol % of CaO, a concentration of CaO in a sputtered region converges to 28.8 mol %. In a case of a pellet containing 88.8 mol % of MgO and 12.0 mol % of CaO, a concentration of CaO in a sputtered region converges to 49.3 mol %.

### 6-2. Experiment 4

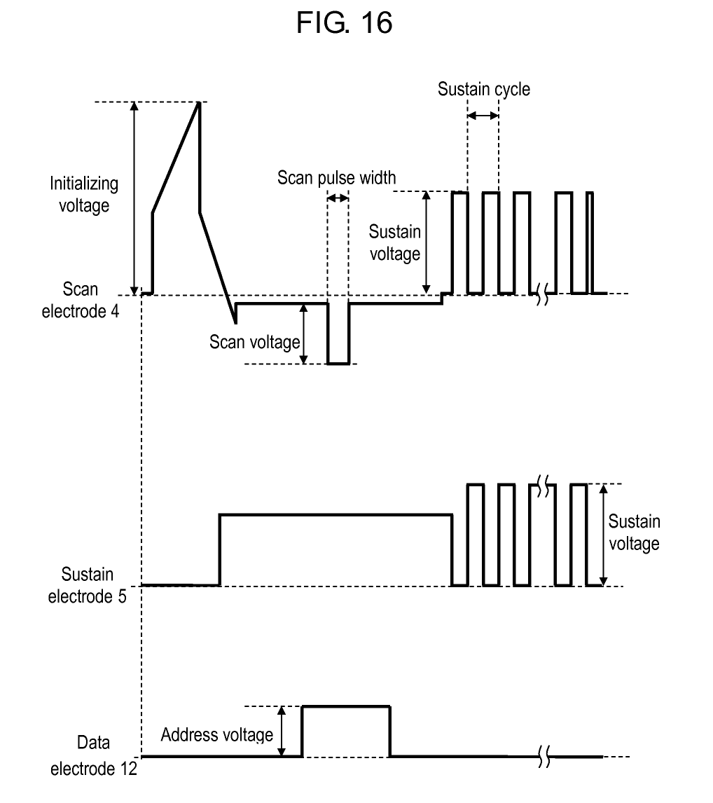

The performance of PDP 1 has been evaluated by measuring a change in sustain voltage. As shown in FIG. 16, a pulse voltage to drive PDP 1 is applied to scan electrode 4, sustain electrode 5, and data electrode 12. A voltage condition applied to PDP 1 in a performance evaluation experiment is as follows. An initializing voltage (fixed) is 330 V, a scan voltage (fixed) is −140 V, a pulse width is 0.6 μs, and an address voltage (fixed) is 70 V, a sustain voltage (fixed) is 200 V, and a sustain cycle is 0.5 μs.

In addition, in the performance evaluation experiment, sustain discharge has been generated in all of the discharge cells in PDP 1. In the comparative example, an initial value of the sustain voltage is 194 V. The sustain voltage is lowered as a sustain discharge time is accumulated. The sustain voltage is lowered to 186 V after a lapse of 400 hours of the cumulative sustain discharge time. Furthermore, the sustain voltage is lowered to 174 V after a lapse of 800 hours of the cumulative sustain discharge time.

Meanwhile, in the working example, an initial value of the sustain voltage is 171 V. Then, even after the sustain discharge time has been accumulated, the sustain voltage is 170 V. Therefore, according to the working example, the sustain voltage at the time of sustain discharge is stable compared to the comparative example.

### 7. Summary

The method for producing PDP 1 is provided, and PDP 1 includes rear plate 10, and front plate 2 arranged so as to be opposed to rear plate 10. Front plate 2 has dielectric layer 8, and protective layer 9 to cover dielectric layer 8. Protective layer 9 includes base film 91 formed on dielectric layer 8. Aggregated particles 92 each composed of aggregated MgO crystal particles are dispersed over the whole surface of base film 91. Base film 91 includes at least the first metal oxide and the second metal oxide. In addition, base film 91 has at least one peak through the X-ray diffraction analysis. The peak of base film 91 exists between the first peak of the first metal oxide through the X-ray diffraction analysis and the second peak of the second metal oxide through the X-ray diffraction analysis. The first peak and the second peak show the same surface orientation as the surface orientation shown by the peak of base film 91. The first metal oxide and the second metal oxide are composed of two kinds of metal oxides selected from the group consisting of MgO, CaO, SrO and BaO.

The method for producing PDP 1 includes the following processes. Protective layer 9 is formed on dielectric layer 8. Then, the surface of protective layer 9 is sputtered and the component of sputtered protective layer 9 is re-deposited, to change the concentration ratios of the first metal oxide and the second metal oxide in the surface of protective layer 9.

According to the method for producing PDP 1, since the surface composition of protective layer 9 can be stabilized, the sustain voltage of PDP 1 can be prevented from fluctuating with discharge time.

In addition, according to the method for producing PDP 1, protective layer 9 can previously come close to be in the state provided after the aging step. Therefore, the time required in aging step 34 can be reduced in the method for producing PDP 1.

### INDUSTRIAL APPLICABILITY

As described above, the technique disclosed in this embodiment is useful for realizing the PDP which is provided with high-definition and high-brightness display performance, and keeps its power consumption low.

### REFERENCE MARKS IN THE DRAWING

1 PDP
2 front plate
3 front glass substrate
4 scan electrode
4a, 5a transparent electrode
4b, 5b bus electrode
5 sustain electrode
6 display electrode
7 black stripe
8 dielectric layer
9 protective layer
10 rear plate
11 rear glass substrate
12 data electrode
13 base dielectric layer
14 barrier rib
15 phosphor layer
16 discharge space
21 scan electrode side interconnect part
22 scan electrode terminal
23 sustain electrode side interconnect part
24 sustain electrode terminal
81 first dielectric layer
82 second dielectric layer
91 base film
92 aggregated particle
92a crystal particle
100 discharge device
102 discharge chamber
104 terminal part
106 cable
108 table
110 DC power supply

1. A method for producing a plasma display panel including a rear plate, and a front plate disposed oppositely to the rear plate, wherein
the front plate has a dielectric layer and a protective layer that covers the dielectric layer,
the protective layer includes a base layer formed on the dielectric layer,
aggregated particles composed of aggregated crystal particles made of a magnesium oxide are dispersed all over the base layer,
the base layer contains at least a first metal oxide and a second metal oxide,
the base layer has at least one peak through an X-ray diffraction analysis,
the peak exists between a first peak of the first metal oxide through an X-ray diffraction analysis and a second peak of the second metal oxide through an X-ray diffraction analysis,
the first peak and the second peak show the same surface orientation as a surface orientation shown by the peak,
the first metal oxide and the second metal oxide are composed of two kinds of oxides selected from a group consisting of a magnesium oxide, a calcium oxide, a strontium oxide, and a barium oxide,
the method comprising:
forming the protective layer on the dielectric layer; and then
changing concentration ratios of the first metal oxide and the second metal oxide in the surface of the protective layer by sputtering the surface of the protective layer and re-depositing a component of the sputtered protective layer.

2. The method for producing the plasma display panel according to claim 1, wherein
the front plate further has a glass substrate, and a display electrode formed on the glass substrate and covered with the dielectric layer, and
the method comprises:
forming the display electrode on the glass substrate; then
forming the dielectric layer to cover the display electrode; then
forming the protective layer on the dielectric layer; then
generating discharge under an inert gas atmosphere by applying a voltage to the display electrode;
sputtering the surface of the protective layer with an ion of the inert gas generated due to the discharge; and
changing the concentration ratio in the surface of the protective layer, by re-depositing the component of the sputtered protective layer.

3. The method for producing the plasma display panel according to claim 2 comprising:
generating the discharge under the inert gas atmosphere by applying a voltage to the display electrode;
sputtering the surface of the protective layer with the ion of the inert gas generated due to the discharge; and
changing the concentration ratio in a discharge region corresponding to a region in which the discharge has been generated in the surface of the protective layer, and the concentration ratio in a non-discharge region corresponding to a region in which the discharge is not generated in the surface of the protective layer, by re-depositing the component of the sputtered protective layer.

4. The method for producing the plasma display panel according to claim 2 comprising:
generating the discharge under the inert gas atmosphere by applying a voltage to the display electrode;
sputtering the surface of the protective layer with the ion of the inert gas generated due to the discharge; and
changing the concentration ratio in a sputtered region in the surface of the protective layer, and the concentration ratio in a non-sputtered region in the surface of the protective layer, by re-depositing the component of the sputtered protective layer.

5. The method for producing the plasma display panel according to claim 3 comprising:
generating the discharge under the inert gas atmosphere by applying a voltage to the scan electrode and the sustain electrode;
sputtering the surface of the protective layer with the ion of the inert gas generated due to the discharge; and
changing the concentration ratio in the surface of the protective layer provided over the display electrode, and the concentration ratio in the surface of the protective layer over which the display electrode is not formed, by re-depositing the component of the sputtered protective layer.

6. The method for producing the plasma display panel according to claim 4 comprising:
generating the discharge under the inert gas atmosphere by applying a voltage to the scan electrode and the sustain electrode;
sputtering the surface of the protective layer with the ion of the inert gas generated due to the discharge; and
changing the concentration ratio in the surface of the protective layer provided over the display electrode, and the concentration ratio in the surface of the protective layer over which the display electrode is not formed, by re-depositing the component of the sputtered protective layer.
